(19) United States
(12) Patent Application Publication
(10) Pub. No.: US 2026/0227562 A1
(43) Pub. Date: Aug. 6, 2026

(54) Composite Optical Film

(71) Applicant: UBRIGHT OPTRONICS CORPORATION, Taoyuan City (TW)

(72) Inventors: Yi-Long Tyan, Taoyuan City (TW); Lung-Pin Hsin, Taoyuan City (TW); Chang-Yu Chou, Taoyuan City (TW); Chien-Chih Lai, Taoyuan City (TW); Ching-An Yang, Taoyuan City (TW); Yu-Mei Juan, Taoyuan City (TW); Te-An Chen, Taoyuan City (TW)

(21) Appl. No.: 19/530,376

(22) Filed: Feb. 5, 2026

Related U.S. Application Data
(60) Provisional application No. 63/754,504, filed on Feb. 5, 2025.

(51) Int. Cl. F21V 8/00

(52) U.S. Cl. CPC G02B 6/0036; G02B 6/0016; G02B 6/0041; G02B 6/0065; G02B 6/0075; G02B 6/0073

(57) ABSTRACT

The disclosure provides a composite optical film with diffusion and light-homogenization functionalities. The composite optical film comprises a multifaceted recess structure and a reverse-prism structure. The composite optical film may be laminated with a lower prism film to form a single integrated 2-in-1 composite optical film structure, or with a lower and an upper prism film to form a single integrated 3-in-1 composite optical film structure.

### CROSS REFERENCE TO RELATED APPLICATION

This application claims the benefit of U.S. provisional patent application No. 63/754,504 , filed on Feb. 5, 2025, which is hereby incorporated herein by reference.

### BACKGROUND

### Field of the Invention

The present invention relates to an optical film for liquid crystal display (LCD) panels, and more particularly to a composite optical film with multifunctional low-diffusion properties and its laminated structure.

### Description of Related Art

With continuous advances in electronic technology, there is an increasing demand for electronic display products that are lightweight, thin, compact, and energy-efficient, and that comply with environmental requirements for energy conservation and carbon reduction. Accordingly, liquid crystal display (LCD) panels have been developed toward reduced thickness, lower power consumption, and enhanced optical efficiency. In addition to reducing the thickness of panel glass substrates, overall panel brightness has been enhanced by improving the luminance performance of optical films used in backlight modules.

In a conventional backlight module, optical films play a critical role in controlling light propagation and improving luminance efficiency. Prism optical films are essential components of the backlight module. Based on principles of refraction and reflection, prism film structures are configured to redirect light toward a forward viewing direction, thereby increasing on-axis luminance. Light emitted outside a predetermined viewing angle, which would otherwise be wasted, may be recycled and reused, resulting in a significant increase in the backlight module's overall brightness. Diffusion films, on the other hand, are generally used to conceal point defects of a light guide plate and to improve luminance uniformity across the module.

Accordingly, a conventional backlight module typically comprises a plurality of optical films, including a light guide plate, a lower-diffusion film, a lower prism film, an upper prism film, and an upper diffusion film, for a total of five optical films arranged in a stacked configuration. However, such a configuration increases the backlight module's overall thickness and may adversely affect power consumption and thermal performance.

### SUMMARY

To address the aforementioned issues, embodiments of the present invention provide a composite optical film that provides diffusion and light homogenization functionalities. The composite optical film comprises a multifaceted recess structure and a reverse-prism structure. The composite optical film may be laminated with a lower prism film to form a single integrated 2-in-1 composite optical film structure, or with a lower and an upper prism film to form a single integrated 3-in-1 composite optical film structure.

By integrating multiple optical functionalities into a single laminated optical film, the number of optical films required in the backlight module may be reduced. Specifically, two or three optical films in a conventional configuration may be combined into a single composite optical film, thereby reducing the overall thickness of the optical stack.

It is therefore that the 2-in-1 or 3-in-1 laminated composite optical film according to embodiments of the present disclosure may improve the overall luminance of the backlight module by approximately 10% to 20%, while simultaneously reducing the total thickness of the optical films. As a result, the backlight module may achieve (1) a reduced module thickness, (2) a reduced number of light-emitting diodes (LEDs), (3) reduced heat generation from the LEDs, and (4) reduced overall power consumption. Accordingly, the disclosed backlight module structure enables both module thinness and improved energy efficiency, thereby satisfying requirements for energy saving and carbon reduction.

In one embodiment, the invention discloses a composite optical film comprising: a first substrate having a bottom surface and a top surface; a plurality of reverse prisms, disposed on the bottom surface of the first substrate; and a plurality of multi-faceted recesses, arranged on the top surface of the first substrate.

In one embodiment, the composite optical film further comprises a plurality of first prisms that is disposed over the plurality of multi-faceted recesses, wherein the plurality of first prisms is disposed on a top surface of a second substrate, and the second substrate is adhered to the plurality of multi-faceted recesses through a first adhesive layer.

In one embodiment, the first adhesive layer comprises a thermally curable resin or a UV-curable resin.

In one embodiment, the first adhesive layer further comprises beads to enhance diffusion.

In one embodiment, the added beads are selected from an organic group consisting of PMMA, PS, and melamine.

In one embodiment, the added beads are selected from an inorganic group consisting of silicon, SiO₂, TiO₂, CaCO₃, Al₂O₃, and ZrO₂.

In one embodiment, the first adhesive layer comprises a matte structure formed by embossing.

In one embodiment, the composite optical film further comprises a plurality of second prisms that is disposed over the plurality of first prisms, wherein the plurality of second prisms is disposed on a third substrate, and the third substrate is adhered to the plurality of first prisms through a second adhesive layer.

In one embodiment, the second adhesive layer comprises a thermally curable resin or a UV-curable resin.

In one embodiment, the second adhesive layer further comprises beads to enhance diffusion.

In one embodiment, the added beads are selected from an organic group consisting of PMMA, PS, and melamine. In one embodiment, the added beads are selected from an inorganic group consisting of silicon, SiO₂, TiO₂, CaCO₃, Al₂O₃, and ZrO₂.

In one embodiment, the second adhesive layer comprises a matte structure formed by embossing.

In one embodiment, the plurality of multi-faceted recesses is an inverted-pyramid microstructure.

In one embodiment, the inverted-pyramid microstructure comprises circular cones or polygonal cones. In one embodiment, the reverse prisms are triangular or semicircular.

The detailed technology and above preferred embodiments implemented for the present invention are described in the following paragraphs accompanying the appended drawings for people skilled in this field to well appreciate the features of the claimed invention.

### BRIEF DESCRIPTION OF DRAWINGS

The foregoing aspects and many of the accompanying advantages of this invention will become more readily appreciated as the same becomes better understood by reference to the following detailed description when taken in conjunction with the accompanying drawings, wherein:

FIG. 1 illustrates a composite, multifunctional, lower-diffusion optical film with a diffusion effect, combining a reverse prism structure and a multi-faceted recess structure;

FIG. 2A illustrates a 3D view of a 2-in-1 composite optical film structure formed by laminating a composite multifunctional lower-diffusion optical film with a lower prism film into a single optical sheet;

FIG. 2B illustrates a cross-sectional view of the 2-in-1 composite optical film structure in FIG. 2A;

FIG. 3A illustrates a 3D view of a 3-in-1 composite optical film structure formed by laminating a composite multifunctional lower-diffusion optical film with a lower prism film and an upper prism film into a single optical sheet;

FIG. 3B illustrates a cross-sectional view of the 3-in-1 composite optical film structure in FIG. 3A;

FIG. 4A illustrates a 3D view of a 2-in-1 composite optical film structure in which a lamination adhesive layer contains added organic or inorganic beads;

FIG. 4B illustrates a cross-sectional view of the 2-in-1 composite optical film structure in FIG. 4A;

FIG. 5A illustrates a 3D view of a 3-in-1 composite optical film structure in which an upper UV-curable adhesive layer contains added organic or inorganic beads;

FIG. 5B illustrates a cross-sectional view of the 3-in-1 composite optical film structure in FIG. 5A;

FIG. 6A illustrates a 3D view of a 3-in-1 composite optical film structure in which both upper and lower UV-curable adhesive layers contain added organic or inorganic beads;

FIG. 6B illustrates a cross-sectional view of the 3-in-1 composite optical film structure in FIG. 6A.

### DETAILED DESCRIPTION OF PREFERRED EMBODIMENTS

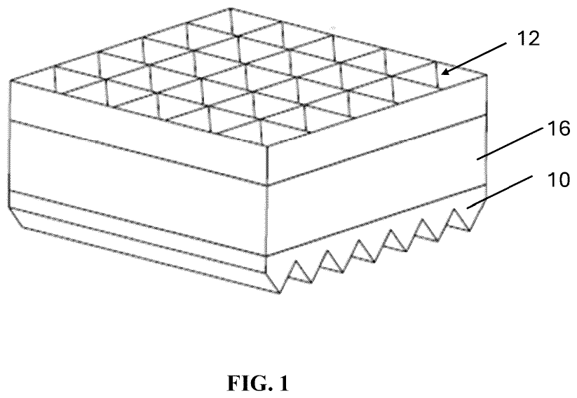

The following preferred embodiments of the present invention use prism structures with different prism angles on the incident surface of a reverse-prism film to determine an optimal prism angle. An emergent surface of the reverse-prism film is provided with an inverted-pyramid microstructure that serves as a diffusion function, thereby forming a multifunctional, low-diffusion composite optical film with defect-masking and brightness-enhancing functions, as shown in FIG. 1.

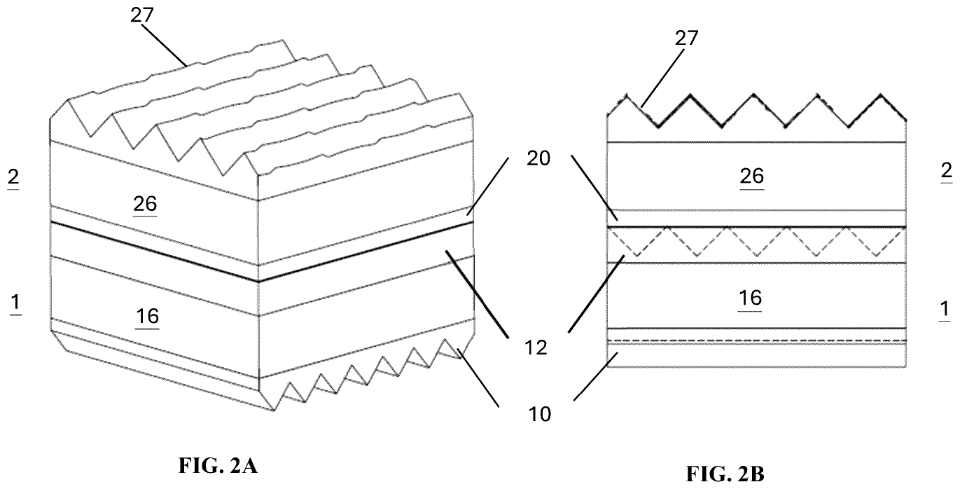

The emergent surface of the multifunctional lower-diffusion composite optical film, that is, the surface having the inverted-pyramid microstructure, is laminated to an incident surface (i.e., a PET surface) of a lower prism film by a lamination process using a UV-curable adhesive layer, such that two optical films are bonded together to form a single integrated 2-in-1 composite optical film, thereby creating a composite optical film structure, as shown in FIG. 2A and FIG. 2B.

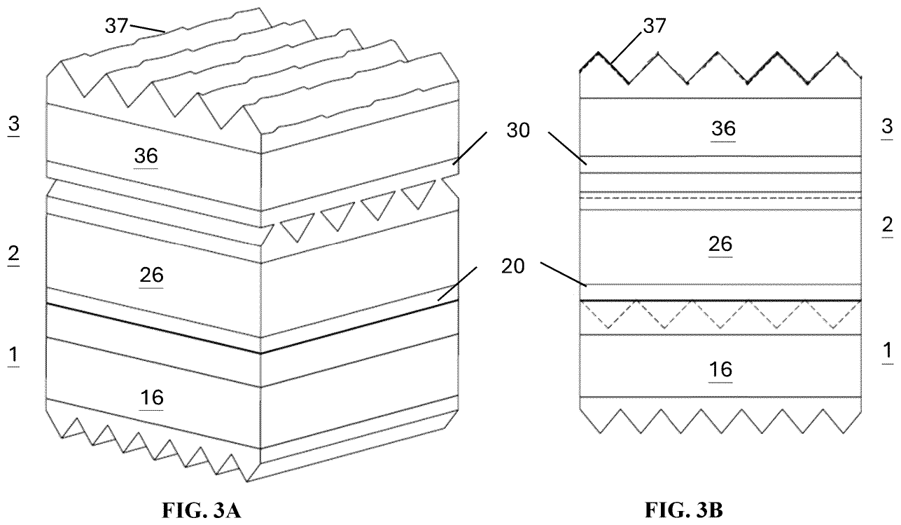

Alternatively, the emergent surface (i.e., a prism-structured surface) of the 2-in-1 composite optical film is further laminated to an incident surface (i.e., a PET surface) of an upper prism film by a lamination process using a UV-curable adhesive layer, such that three optical films are bonded together to form a single integrated 3-in-1 composite optical film, thereby creating a composite optical film structure, as shown in FIG. 3A and FIG. 3B.

The above-described 2-in-1 and 3-in-1 composite optical films may, respectively, increase brightness by approximately 10%-20%. They may effectively reduce the thickness and material cost of a backlight module (Back Light Unit, BLU) by approximately one-third to one-half, reduce the number of LEDs required, lower the heat generation temperature of LEDs in the backlight module, reduce overall power consumption, reduce transportation volume and cost, and simplify BLU assembly, thereby achieving multiple benefits including module thinness and energy saving with carbon reduction.

As shown in FIG. 1, a composite, multifunctional, low-diffusion optical film 1 with a diffusion effect, comprising a reverse-prism structure 10 and a multifaceted recess structure 12, is schematically illustrated. The reverse prism structure 10 and a multi-faceted recess structure 12 are formed on a substrate 16, which may be made of PET, PEN, PAr, PC, or TAC. The reverse-prism structure 10 comprises triangular and semicircular pyramids, and the prism tips exhibit varying heights. The prism angle ranges from 50 to 140 degrees, preferably from 65 to 125 degrees. Preferably, the multi-faceted structure includes inverted pyramids with circular or polygonal cones. Based on an isotropic light-collecting principle of the reverse prism structure 10, and by employing the reverse prism film having a specific prism angle, light emitted from a light guide plate may be redirected substantially vertically upward, thereby increasing the utilization of light emitted from the light guide plate by approximately 10% to 30%. In addition, by providing the emergent surface with an inverted-pyramid microstructure 12 that serves as a diffusion function, luminance uniformity and defect-masking effects are achieved. Accordingly, diffusion functionality may be maintained while the overall brightness gain of the composite optical film is effectively enhanced.

The multifaceted recess structure 12 comprises a plurality of multifaceted recesses.

In one embodiment, the multi-faceted recess comprises at least four side surfaces.

In one embodiment, multiple multi-faceted recesses of the plurality of multi-faceted recesses are distributed side by side along the length of the substrate, and multiple multi-faceted recesses of the plurality of multi-faceted recesses are distributed side by side along the width of the substrate. That is, there is no gap between two adjacent multi-faceted recesses and there is no gap between two adjacent multi-faceted recesses.

The reverse prism structure 10 comprises a plurality of reverse prisms.

The composite optical film structure, as disclosed in FIG. 1, incorporating a diffusion function provided by an inverted-pyramid microstructure and combined with a reverse prism exhibits the following characteristics: (1) The composite optical film is configured to replace a conventional lower-diffusion film, and therefore does not increase the overall thickness of the backlight module; (2) the composite optical film does not adversely affect the overall optical chromaticity of the backlight module; (3) the overall luminance of the backlight module may be increased by approximately 10% to 20%.

As shown in FIG. 2A and FIG. 2B, a 2-in-1 composite optical film structure formed by laminating a composite multifunctional lower-diffusion optical film 1 with a lower prism film 2 into a single optical sheet is schematically illustrated. The lower prism film 2 includes a substrate 26 and a plurality of first prisms 27 disposed on a top surface of the substrate 26, and the substrate 26 is adhered to the plurality of multi-faceted recesses through a first adhesive layer 20, which may be made of PET, PEN, PAr, PC, or TAC. To achieve a reduced thickness and simplified assembly of the composite optical film, the embodiment of FIG. 2A and FIG. 2B employs a lamination process in which the emergent surface of the multifunctional lower-diffusion composite optical film (i.e., the inverted-pyramid microstructure surface) 12 is laminated to the incident surface (i.e., a PET surface) of a lower prism film 2 using a thermal-curable or UV-curable adhesive layer 20, such that two optical films are bonded together to form a single integrated 2-in-1 composite optical film, as shown in FIG. 2A and FIG. 2B.

As such, the composite optical film structure, as disclosed in FIG. 2A and FIG. 2B, formed by combining a diffusion function provided by an inverted-pyramid microstructure with a reverse prism, and further laminating the structure with a lower prism film to create a single integrated 2-in-1 composite optical film, exhibits the following characteristics: (1) the composite optical film is configured to replace a conventional lower-diffusion film and a conventional lower prism film, thereby effectively reducing the overall thickness of the backlight module; (2) the composite optical film does not adversely affect the overall optical chromaticity of the backlight module; (3) the overall luminance of the backlight module may be substantially maintained; (4) the thickness and material cost of the backlight module (Back Light Unit, BLU) may be reduced by approximately one-third to one-half; (5) the transportation volume and associated transportation costs may be reduced; (6) assembly complexity and assembly costs of the BLU may be reduced.

As shown in FIG. 3A and FIG. 3B, a 3-in-1 composite optical film structure, formed by laminating a composite multifunctional lower-diffusion optical film with a lower prism film and an upper prism film into a single optical sheet, is schematically illustrated. The lower prism film 2 includes a substrate 26 and a plurality of first prisms 27 disposed on a top surface of the substrate 26, which may be made of PET, PEN, PAr, PC, or TAC. Similarly, the upper prism film 3 includes a substrate 36 and a plurality of first prisms 37 disposed on a top surface of the substrate 36, which may be made of PET, PEN, PAr, PC, or TAC. In FIG. 3A and FIG. 3B, the emergent surface of the multifunctional lower-diffusion composite optical film 12 (i.e., the inverted-pyramid microstructure surface) is first laminated to the incident surface (i.e., a PET surface) of a lower prism film using a thermal curable UV-curable adhesive layer 20 to form the 2-in-1 composite optical film. The 2-in-1 composite optical film is then laminated to the incident surface (i.e., the PET surface) of the upper prism film using another thermal-or UV-curable adhesive layer 30, thereby bonding the three optical films to form a single integrated 3-in-1 composite optical film structure.

Thus, the composite optical film structure, as disclosed in FIG. 3A and FIG. 3B, formed by combining a diffusion function provided by an inverted-pyramid microstructure with a reverse prism, and further laminating the structure with a lower prism film and an upper prism film to form a single integrated 3-in-1 composite optical film, exhibits the following characteristics: (1) the composite optical film is configured to replace a conventional lower-diffusion film, a conventional lower prism film, and a conventional upper prism film, thereby effectively reducing the overall thickness of the backlight module; (2) the composite optical film does not adversely affect the overall optical chromaticity of the backlight module; (3) the overall luminance of the backlight module may be substantially maintained; (4) the thickness and material cost of the backlight module (Back Light Unit, BLU) may be reduced by approximately one-third to one-half; (5) the transportation volume and associated transportation costs may be reduced; (6) assembly complexity and assembly costs of the BLU may be reduced.

The prism structures of the upper and lower prism films in the single-sheet 3-in-1 laminated prism composite optical film and/or the lower prism film in the single-sheet 2-in-1 laminated prism composite optical film may employ prism tips having height variations, such as H-type or G-type structures, or configurations including one high and one low prism tip, or one high and two low prism tips. Such configurations may effectively reduce adhesion and sticking issues between adjacent optical films.

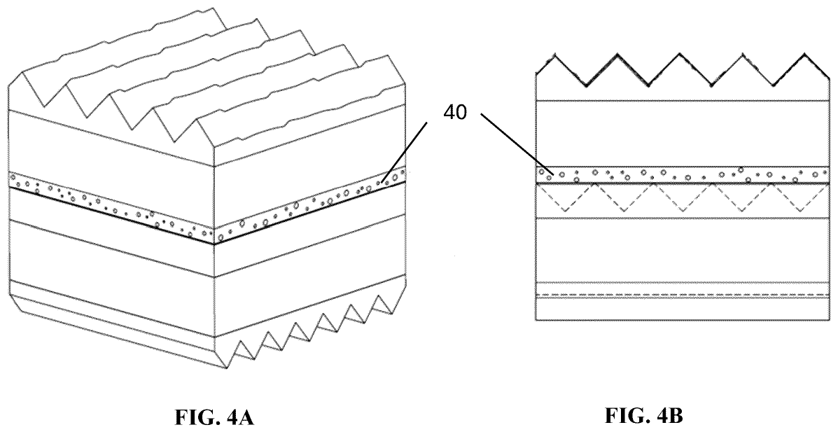

Moreover, the UV-curable adhesive layer used to laminate the multifunctional lower-diffusion composite optical film and the lower prism film in the single-sheet 2-in-1 composite optical film may be a clear UV adhesive. Alternatively, a matte adhesive layer 40 having a diffusion effect may be used. The matte treatment may include adding organic or inorganic beads (beads) into the thermal-curable or UV adhesive or forming a matte surface by embossing (matte embossing), thereby providing defect-masking and anti-rainbow (mura) effects, as shown in FIG. 4A and FIG. 4B. For example, the added beads comprise diffusion beads selected from organic beads and inorganic beads, wherein the organic beads comprise PMMA, PS, or melamine, and the inorganic beads comprise silicon, SiO₂, TiO₂, CaCO₃, Al₂O₃, or ZrO₂, having a haze ranges from 2% to 60%, and, preferably, ranging from 10% to 30%. If the matte adhesive layer 40 is formed as a matte coating by embossing, the haze value ranges from 2% to 60%. Accordingly, the lower diffusion film may be omitted, thereby achieving both reduced thickness and high brightness.

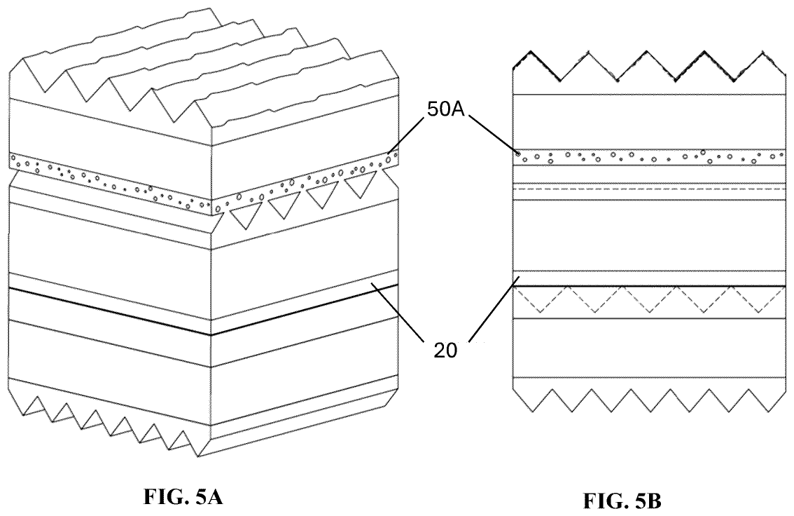

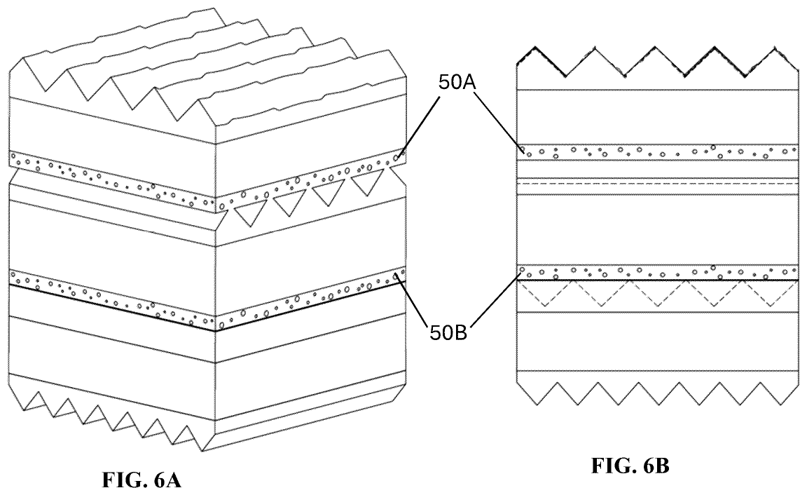

Furthermore, the UV-curable adhesive layer used to laminate the multifunctional lower-diffusion composite optical film, the lower prism film, and the upper prism film in the single-sheet 3-in-1 composite optical film may be a clear UV adhesive, as shown in FIG. 3A and FIG. 3B, or a matte adhesive layer 50A and/or 50B with a diffusion effect. The matte treatment may include adding organic or inorganic beads (beads) into the UV adhesive or forming a matte surface by embossing, thereby providing defect-masking and anti-rainbow effects, as shown in FIG. 5A, FIG. 5B, FIG. 6A and FIG. 6B. For example, the added beads comprise diffusion beads selected from organic beads and inorganic beads, wherein the organic beads comprise PMMA, PS, or melamine, and the inorganic beads comprise silicon, SiO₂, TiO₂, CaCO₃, Al₂O₃, or ZrO₂, having a haze ranges from 2% to 60%, and, preferably, ranging from 10% to 30%. If the matte adhesive layer 40 is formed as a matte coating by embossing, the haze value ranges from 2% to 60%. Accordingly, the upper and lower diffusion films may be omitted, thereby achieving both reduced thickness and high brightness.

Accordingly, an upper diffusion film may be omitted to achieve reduced thickness and high brightness.

Therefore, the single-sheet 2-in-1 or 3-in-1 composite optical film formed by laminating the multifunctional lower-diffusion composite optical film with the lower prism film and/or the upper prism film may have a lamination adhesion strength greater than 50 g/25 mm. When an adhesive containing organic or inorganic beads is used, the haze of the adhesive layer can be controlled to approximately 1%-60%.

Based on the isotropic light-collection principle of a reverse prism film, and employing a reverse prism film with a specific prism angle, as shown in FIG. 1, light emitted from a light guide plate may be redirected substantially vertically upward. As a result, the utilization of light emitted from the light guide plate may increase by approximately 10% to 30%. In addition, the emergent surface is provided with an inverted-pyramid microstructure with diffusion functionality, thereby achieving light homogenization and defect-masking. Accordingly, while diffusion functionality is maintained, the overall brightness gain of the composite optical film may be effectively enhanced.

To achieve a reduced thickness and simplified assembly of the composite optical film, the present invention employs a lamination technique in which an emergent surface of the multifunctional lower-diffusion composite optical film (i.e., the inverted-pyramid microstructure surface) is laminated to an incident surface (i.e., a PET surface) of a lower prism film using a UV-curable adhesive layer. Thus, two optical films are bonded together to form a single integrated 2-in-1 composite optical film, thereby creating a composite optical film structure, as shown in FIG. 2A and FIG. 2B.

Alternatively, the emergent surface of the multifunctional lower-diffusion composite optical film (i.e., the inverted-pyramid microstructure surface) is first laminated to the incident surface (i.e., a PET surface) of the lower prism film using a UV-curable adhesive layer to form the 2-in-1 composite optical film. Thereafter, the 2-in-1 composite optical film is laminated to the incident surface (i.e., the PET surface) of the upper prism film using a UV-curable adhesive layer, thereby bonding three optical films to form a single integrated 3-in-1 composite optical film structure, as shown in FIG. 3A and FIG. 3B.

In summary, the above-described composite optical film structure, which integrates isotropic light-collecting characteristics of a reverse prism film with diffusion and light-homogenization functions provided by an inverted-pyramid microstructure, and which is laminated with a lower prism film and optionally an upper prism film to form a single-sheet 2-in-1 or 3-in-1 composite optical film, provides the following advantages:
1. Under the same backlight module configuration, use of the multifunctional composite diffusion optical film combining the isotropic light-collecting characteristics of the reverse prism film and the inverted-pyramid microstructure having diffusion and light-homogenization functions may increase the overall module luminance by approximately 10% to 20%.
2. When the multifunctional composite diffusion optical film is laminated with a lower prism film, and optionally an upper prism film to form a single-sheet 2-in-1 or 3-in-1 prism composite optical film using an adhesive without added organic or inorganic beads (beads), high brightness requirements may be satisfied while effectively reducing the thickness of the backlight module (Back Light Unit, BLU).
3. The number of LEDs required may be reduced, and the overall power consumption of the backlight module may be improved, thereby achieving the benefits of reduced thickness, energy saving, and carbon reduction.
4. When the multifunctional composite diffusion optical film is laminated with a lower prism film and optionally an upper prism film to form a single-sheet 2-in-1 or 3-in-1 prism composite optical film using an adhesive containing added organic or inorganic beads (beads), an upper diffusion film may be replaced, thereby achieving both reduced thickness and high brightness. In such a configuration, the overall thickness of the backlight module (BLU) may be reduced by approximately one-third to one-half.
5. The single-sheet 2-in-1 or 3-in-1 prism composite optical film may further improve thermal stability and anti-wrinkle performance of the composite optical film.
6. The composite optical film structure does not adversely affect the overall optical chromaticity of the backlight module.
7. Transportation volume and associated transportation costs may be reduced, and assembly complexity and assembly costs of the BLU may be simplified.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they are substantially covered in the appended claims.

What is claimed is:

1. A composite optical film comprising:
a first substrate having a bottom surface and a top surface;
a plurality of reverse prisms, disposed on the bottom surface of the first substrate; and
a plurality of multi-faceted recesses, disposed on the top surface of the first substrate.

2. The composite optical film according to claim 1, wherein a plurality of first prisms is disposed over the plurality of multi-faceted recesses, wherein the plurality of first prisms is disposed on a top surface of a second substrate, and the second substrate is adhered to the plurality of multi-faceted recesses through a first adhesive layer.

3. The composite optical film according to claim 2, wherein the first adhesive layer comprises a thermally curable resin or a photo-curable resin.

4. The composite optical film according to claim 2, wherein the first adhesive layer further comprises added beads to provide a diffusion effect.

5. The composite optical film according to claim 2, wherein the first adhesive layer comprises a matte structure formed by embossing.

6. The composite optical film according to claim 2, wherein a plurality of second prisms is disposed over the plurality of first prisms, wherein the plurality of second prisms is disposed on a third substrate, and the third substrate is adhered to the plurality of first prisms through a second adhesive layer.

7. The composite optical film according to claim 6, wherein the second adhesive layer comprises a thermally curable resin or a photo-curable resin.

8. The composite optical film according to claim 6, wherein the second adhesive layer further comprises added beads to provide a diffusion effect.

9. The composite optical film according to claim 6, wherein the second adhesive layer comprises a matte structure formed by embossing.

10. The composite optical film according to claim 1, wherein the plurality of multi-faceted recesses is an inverted-pyramid microstructure.
